(19) United States
(12) Patent Application Publication
(10) Pub. No.: US 2026/0350892 A1
(43) Pub. Date: Nov. 5, 2026

(54) PARALLELIZING THE DIFFUSION MODEL FOR BREAST CT IMAGE RECONSTRUCTION FROM SPARSE CONE-BEAM PROJECTIONS

(71) Applicant: Rensselaer Polytechnic Institute, Troy, NY (US)

(72) Inventors: GE WANG, Loudonville, NY (US); WENJUN XIA, Troy, NY (US); CHUANG NIU, Troy, NY (US); WENXIANG CONG, Albany, NY (US)

(73) Assignee: Rensselaer Polytechnic Institute, Troy, NY (US)

(21) Appl. No.: 19/487,205

(22) PCT Filed: May 22, 2024
(86) PCT No.: PCT/US2024/030455

§ 371 Date: Nov. 24, 2025

Related U.S. Application Data
(60) Provisional application No. 63/468,038, filed on May 22, 2023.
(60) Provisional application No. 63/566,982, filed on Mar. 19, 2024.

(51) Int. Cl. G06T 12/30; G06N 3/0455; G06T 5/77; G06T 12/10

(52) U.S. Cl. CPC G06T 12/30; G06N 3/0455; G06T 5/77; G06T 12/10; G06T 2211/441

(57) ABSTRACT

Systems, methods, and software for reconstructing sparse projection data to full projection data and refining the resulting image volume using denoising diffusion probabilistic models in both the projection and image domains. A trained DDPM in the projection domain is used to inpaint projection data into sparse sub-volumes of a sparce projection dataset. The repaired sub-volumes are assembled into an assembled full projection dataset, which is then reconstructed into an image volume. A trained DDPM in the image domain then refines sub-volumes of the reconstructed image volume to produce a refined tomographic image volume.

### CROSS REFERENCE TO RELATED APPLICATION(S)

This application claims the benefit of U.S. Provisional Application No. 63/468,038, filed May 22, 2023, and U.S. Provisional Application No. 63/566,982, filed Mar. 19, 2024, both of which are incorporated by reference as if disclosed herein in their entireties.

### GOVERNMENT LICENSE RIGHTS

This invention was made with government support under award numbers EB032716, EB031102, HL151561, and CA233888, all awarded by the National Institutes of Health (NIH). The government has certain rights in the invention.

### FIELD

The present disclosure relates to sparse tomographic imaging, in particular to denoising diffusion probabilistic models for sparse tomographic imaging.

### BACKGROUND

In tomographic imaging, tomographic (i.e., measurement) data is acquired, then an image may be reconstructed from the tomographic data. For example, in computed tomography (CT), projection data (sinogram) is acquired and a corresponding image may then be reconstructed using, for example, filtered back projection (FBP). As is known, CT exposes a test subject to ionizing radiation, and test times associated with MRI are relatively long.

### SUMMARY

Some embodiments of the present technology provide methods, systems, and software for tomographic reconstruction from sparse projection data to full projection data using denoising diffusion probabilistic models (DDPM) in both the projection domain and the image domain. A trained DDPM in the projection domain is used to inpaint projection data into sparse sub-volumes of a sparce projection dataset. The repaired sub-volumes are assembled into an assembled full projection dataset, which is then reconstructed into an image volume. A trained DDPM in the image domain then refines sub-volumes of the reconstructed image volume to produce a refined tomographic image volume. In some embodiments, the sub-volumes in each of the projection and image domains are processed in parallel using a distributed computing system.

Various embodiments of the technology will now be described with reference to the drawings.

### BRIEF DESCRIPTION OF DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1 is a graphic illustrating the forward and reverse diffusion processes in the projection and image domains of the conditional DDPMs according to an embodiment of the present technology.

FIG. 2 is schematic illustration of a conditional dual-domain DDPM according to the embodiment of FIG. 1.

FIG. 3 illustrates a functional block diagram of a system according to an embodiment of the present disclosure.

Although the following Detailed Description will proceed with reference being made to illustrative embodiments, many alternatives, modifications, and variations thereof will be apparent to those skilled in the art.

### DETAILED DESCRIPTION

Sparse tomographic imaging may be utilized to reduce radiation dose for CT or to reduce data acquisition time for MRI. In sparse tomographic imaging, tomographic data acquisitions are reduced relative to full tomographic imaging. For example, in sparse CT imaging, a subset of possible views may be acquired, such that fewer tomographic data points are captured within a particular scan range. Image reconstruction from sparse tomographic data (i.e., sparse image reconstruction) may result in image artifacts. Deep learning techniques (e.g., artificial neural networks (ANNs)) may be applied to sparse image reconstruction. The ability of ANNs to remove the artifacts when working only in the image domain may be relatively limited. Deep learning-based tomographic data processing can achieve a better anti-artifact performance, but typically utilizes feature maps of an entire image in a video memory, which makes handling large-scale or three-dimensional (3D) images relatively challenging.

For example, a primary challenge with breast cone-beam CT is the associated radiation exposure. Given the fact that X-ray radiation can induce cancer, there has been significant concern about the risk of CT scans to the patient. The ALARA (“as low as reasonably achievable”) principle is to mitigate this risk. Studies show that the median mean glandular dose (MGD) from breast CT exams is 3 to 4 times higher than that from standard digital mammography, exceeding the limits set by the Mammography Quality Standards Act (MQSA). Addressing this challenge involves reducing the radiation dose of breast CT scans to about ½ to ⅓ of the current levels, aligning with acceptable standards for regular screening. This reduction is technically feasible, with sparse-view breast CT being an emerging method of choice. For breast CT and other CT imaging applications, it is important to maintain high-quality imaging with under-sampled projections, which places high demands on image reconstruction algorithms.

In the image reconstruction field, diffusion models have recently come to the forefront. In particular, denoising diffusion probabilistic model (DDPM)-based deep learning models have emerged as a potential solution for image processing, generation, and reconstruction. With DDPMs ability to transform normally distributed noise into a desirable image through a series of variational autoencoders (VAEs), include capabilities such as image super-resolution, image inpainting, and image editing.

However, applying DDPM to breast CT and other CT imaging applications must address the large size of such CT data and image data and the intensive computational cost of the diffusion process.

Generally, this disclosure relates to the parallelization of DDPM processing in the projection and image domains for CT reconstruction. In some embodiments of the present technology, an apparatus, method and/or system includes divides the image reconstruction process into parallel sub-processes in both the projection and image domains. In some embodiments, this division is based on handling sub-volumes of projection and image data, which are processed by two distinct DDPMs. In some embodiments, these sub-volumes are first assembled into a comprehensive dataset of projections. Then, the Feldkamp-Davis-Kress (FDK) algorithm is employed for domain transformation, and sub-volumes of the resultant image volume are extracted for further refinement via DDPM again.

In some embodiments, the independence of these sub-volumes is maintained to allow for implementation of a parallel processing pipeline in a distributed computing system. In some embodiments, this structure involves minimal data broadcasting during the domain transformation phase, which is advantageous for the overall efficiency of the process.

As used herein, tomographic data may include, but is not limited to, projection data associated with a CT scan or with any other imaging modalities where acquired measurement data may be sparse.

By way of background, DDPM is a generative technique configured to generate sample datasets that correspond to a given probability distribution. In a DDPM process, noise (e.g., Gaussian noise) is gradually added to an image, transforming the image through a plurality of latent spaces to a Gaussian distribution. The DDPM technique is then configured to train a network to learn the denoising process to trace the latent spaces backward for a generated image out of the original distribution.

A parallel DDPM technique, according to some embodiments of the present technology, is configured to enhance a resulting image reconstruction when the tomographic data is sparse. The DDPM technique is configured to operate in both the projection domain and the image domain. The DDPM technique includes two stages: training and sampling (i.e., inference). The training stage corresponds to a (forward) diffusion process and the sampling stage corresponds to a reverse diffusion process. In the training stage in some embodiments, an artificial neural network (ANN), e.g., a U-Net, is trained to learn the reverse diffusion process for generating fully sampled projection sub-volumes. In the sampling stage, data missing from sparse sub-volumes is inpainted to form repaired sub-volumes. “Inpainting” refers to the process of filling in missing data in a dataset. For example, in the context of the present technology, inpainting a sparse CT projection data set would include filling in data between and around the measured projection data to form a full or more complete projection dataset.

In some embodiments, the repaired sub-volumes are then assembled into a complete projection dataset. An image may then be directly reconstructed using a reconstruction technique, e.g., filtered back-projection (FBP) such as the FDK algorithm. In the image domain, in some embodiments, the image volume is divided into a number of non-overlapped sub-volumes, which are refined using a second DDPM. Finally, in some embodiments, the refined sub-volumes are gathered and assembled into a complete high-quality image volume. In some embodiments, through data broadcasting, a distributed computing system enables parallel processing with each of the projection and image domains for increased speed and efficiency. In some embodiments, the technology is implemented on a clout computing platform.

By way of background, in some embodiments, a conditional DDPM may be utilized to inpaint projection data into sparse projection sub-volumes as well as to refine image data in image data sub-volumes, as will be described in more detail below using CT as an example. However, this disclosure is not limited in this regard, and a similar technique may apply to sparse data related to other imaging techniques.

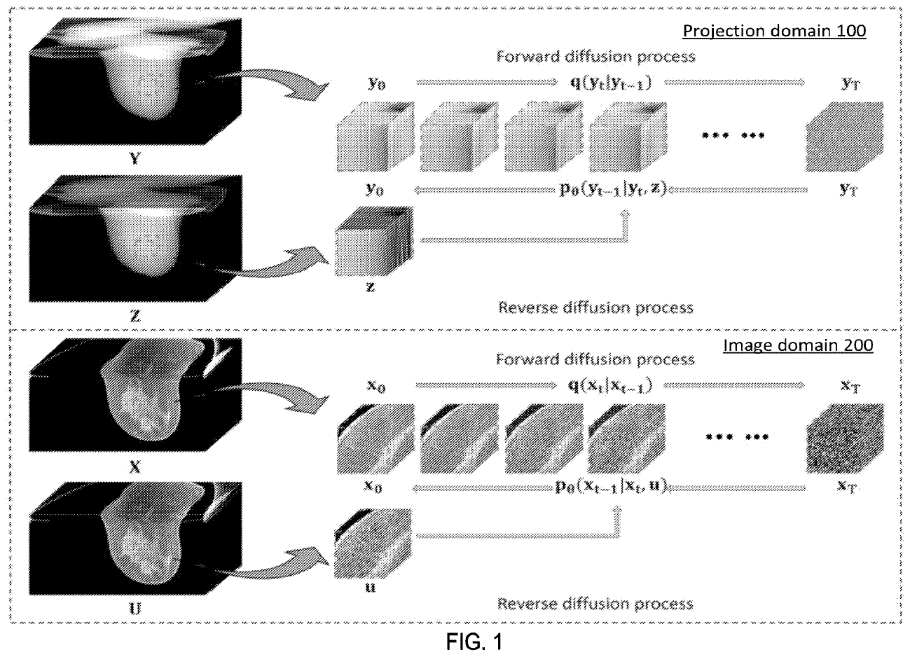

For the fully sampled breast CT projection data Y and the corresponding sparse-view projection data Z, the DDPM comprises a forward process and a reverse process in some embodiments. FIG. 1 provides a schematic illustration of these processes in both the projection domain 100 and image domain 200. Given a time series {1, 2, . . . , t , . . . T}, the forward process of DDPM gradually adds Gaussian noise to each high-quality sub-volume of projection data y extracted from Y. The data distribution at each time step only depends on the previous state, satisfying the Markov property:

q(yₜ|yₜ₋₁)= [symbol] (yₜ|\sqrt{1−βₜ}yₜ₋₁,βₜI), (1)

where q(y₀)=q(y), and β={=β₁, β₂, . . . βd} is a predefined variance schedule. When the number of steps is large enough, the noisy sub-volume will gradually approach the standard normal distribution; i.e., y_{T}~ [symbol] (0, I). By the nature of the Gaussian distribution, the noised sub-volume at any timestamp can be directly obtained:

yₜ=\sqrt{α̅ₜ}y₀+\sqrt{1−α̅ₜ}ϵ, (2)

where αₜ=1−βₜ,

$${\overline{α}}_{t} = {\prod }_{i = 1}^{t} {α}_{i} ,$$

and ϵ~ [symbol] (0, I) is the noise added into the sub-volume.

The reverse process starts from a pure noisy sub-volume y_{T} and moves backward step-by-step. At each step of the reverse process, the network is used to predict the noise ϵ added to the sub-volume yₜ, and then obtain the mean of the posterior distribution of yₜ₋₁, which is used as the denoised sub-volume. The process continues until it reaches the initial time step, producing the final denoised sub-volume y₀. For projection data inpainting in some embodiments, the degraded sub-volume of projection data or image data into the network is used as the condition:

$${y}_{t - 1} = \frac{1}{\sqrt{{\overline{α}}_{t}}} ( {y}_{t} - \frac{1 - {α}_{t}}{\sqrt{1 - {\overline{α}}_{t}}} {ϵ}_{θ} ( {y}_{t} , z , t ) ) + {σ}_{t} ξ , \qquad ( 3 )$$

where ϵ_{θ} is the network parameterized with θ for predicting the noise ϵ, z represents a sub-volume of down-sampled projection data Z, and ξ~ [symbol] (0, I) denotes the noise used for sampling. The loss function for training the noise prediction model in some embodiments is expressed as:

$$ℒ = {𝔼}_{y , z} {𝔼}_{ϵ , t} [ {‖ ϵ - {ϵ}_{θ} ( \sqrt{{\overline{α}}_{t}} {y}_{0} + \sqrt{1 - {\overline{α}}_{t}} ϵ , z , t ) ‖}_{2}^{2} ] . \qquad ( 4 )$$

In some embodiments, the underlying principle of DDPM in the image domain is the same as that of DDPM in the projection domain. FIG. 1 also schematically illustrates the image domain processes. The high-quality sub-volume inputx for the network is derived from the high-quality CT image X, which is reconstructed from a full scan dataset. Meanwhile, in some embodiments, the condition u is obtained from the degraded CT image U, which is reconstructed from projection data inpainted by DDPM in the projection domain.

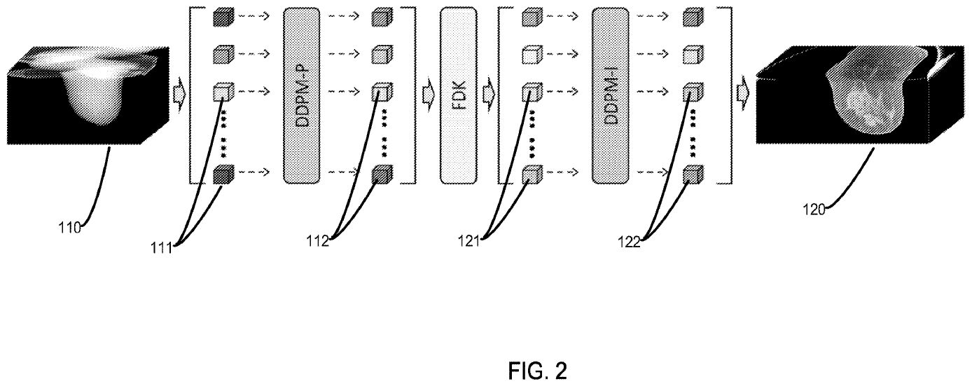

FIG. 2 schematically illustrates two separate DDPMs for projection data and image data according to an embodiment of the present technology, denoted as DDPM-P and DDPM-I respectively. During the breast CT reconstruction from sparse-view data using the trained DDPMs in an embodiment, the projection data 110 is initially divided into a number of non-overlapped sub-volumes 111. Then, the missing data is restored using DDPM-P. In a distributed system, these sub-volume inpaintings are executed in parallel in some embodiments. Once all sub-volumes are repaired 112, each thread acquires the repaired results of all sub-volumes through data broadcasting in some embodiments. The sub-volumes are subsequently assembled into a full dataset. The repaired complete projection dataset is reconstructed using the FDK algorithm in some embodiments.

Similar to the DDPM process in the projection data domain, the generated image volume is divided into a number of non-overlapped sub-volumes 121 in some embodiments. These sub-volumes are refined using DDPM-I in parallel, in some embodiments, to form corresponding refined image sub-volumes 122. Finally, in some embodiments, all sub-volumes are gathered and assembled into a complete high-quality image volume 120 through data broadcasting. In some embodiments, this entire workflow is intrinsically parallel, making sub-volume processing feasible on a regular GPU and computationally more efficient. In some embodiments, this pipeline is implemented on a cloud computing platform for deployment.

In an embodiment related to a cone-beam breast CT application, datasets were acquired using a prototype cone-beam breast CT scanner (KBCT1000, Koning Corp., Norcross, GA, USA). This system is equipped with a tungsten-anode mammography-format X-ray tube (RAD71SP, Varex Imaging, Salt Lake City, UT, USA), operating at 49 kV with a 1.4 mm half-value layer (HVL). It also features an amorphous silicon flat-panel detector (PaxScan 4030CB, Varex Imaging, Salt Lake City, UT, USA). The detector panel array is composed of 768×1024 units, each measuring 388×388 μm². The nominal image resolution is set at 1024×1024 pixels, with the number of slices varying according to the actual breast size, and each voxel size measuring 273.4³ μm³.

In this embodiment, a total of 105 full-scan cone-beam datasets were collected. Of these, 84 were designated for the training set and the remaining 21 for testing purposes. The original full-scan dataset spanned an angular range of 360 degrees and comprised of 300 views. This data was downsampled to 150 views half-dose experiments and to 100 views for one-third dose experiments.

In some embodiments, the architecture of the DDPM-P and DDPM-I is an enhanced variant of the U-net model. A U-Net is a convolutional neural network that includes only convolutional layers, and is a relatively popular architecture for medical image segmentation. Each U-Net is an asymmetrical network that includes one or more Encoder and Decoder units. In some embodiments, this architecture is employed in both the DDPM for projection data (DDPM-P) and the DDPM for image data (DDPM-I). In other embodiments, other artificial neural network (ANN) architectures are implemented consistent with the present disclosure.

In this embodiment, the DDPM-P and DDPM-I were trained separately. Initially, DDPM-P is trained on full-scan projection data. In this embodiment, random 16×16×16 sub-volumes were selected from each dataset and these were paired with corresponding sub-volumes from the sparse-view dataset to create pairs of fully-sampled and down-sampled data for training.

In this embodiment, the diffusion process in the models is set to 1,000 time steps, with a beta schedule linearly spaced between 1e-4 and 2e-2. In this embodiment, the AdamW optimizer was used with an initial learning rate of 1e-4, which was gradually reduced to 1e-5 over the course of training. The total number of training iterations for DDPM-P in this embodiment is set at 0.5 million.

Upon completion of DDPM-P training, the trained DDPM-P is used to recover missing data in the sparse training dataset in this embodiment. Then, in this embodiment, the Feldkamp-Davis-Kress (FDK) algorithm was used to reconstruct an image volume from this data to form a training image volume. In this embodiment, the initial quality of the reconstructed images in the training image volume is suboptimal. To train DDPM-I to improve the image quality, DDPM-I was trained in this embodiment using pairs of these low-quality training image sub-volumes and their corresponding target high-quality sub-volumes. In this embodiment, the training methodology and parameters for DDPM-I mirror those used for DDPM-P.

During the testing phase in this embodiment, the trained DDPMs are applied to the test dataset within a parallel computing pipeline. In both the projection and image domains in this embodiment, the size of the sub-volumes was uniformly set to 16×16×16, with a stride of (16,16,16) for extracting the sub-volumes.

In this embodiment, all training and inference processes were conducted on 1,576 Nvidia V100 GPUs. This embodiment was applied to a sparse-view cone-beam breast CT, including datasets emulating two levels of radiation dose: half dose and one-third dose. The fully sampled projection data comprised 300 views, with the half-dose and one-third dose datasets comprised of 150 and 100 views respectively. The resulting image quality was evaluated through visual inspection. In the half-dose results, the dual-domain DDPM-based structure of this embodiment accurately restored gland structure and reduced noise and artifacts, as compared to older methods and DDPM-P by itself and DDPM-I by itself. In the one-third dose results, the dual domain DDPM architecture again stood out in terms of restoring gland structure and closely matched the ground truth images.

Thus, some embodiments of the present technology address the two major challenges for high-volume CT image reconstruction, such as breast CT imaging, using DDPM technology: the CT volume is large owing to its high image resolution, and the generic diffusion process takes thousands of iterations taking prohibitively long computational time. Some embodiments of the present technology address both the challenges by implementing a parallel DDPM model in the dual-domains of projection and image. Experimental results demonstrate the superiority of some embodiments of the present technology, as the parallel dual-domain DDPM has been found to outperform traditional reconstruction methods.

Thus, some embodiments of the present diffusion-based reconstruction pipeline, designed for independent sub-volumes in parallel, is well suited for deployment in a distributed computing system. This approach is consistent with the ongoing evolution of deep learning, in some embodiments, where large models increasingly benefit from cloud platforms.

Although some embodiments of the present technology have been applied to CT breast imaging, the present technology is equally applicable to other cases such as high-resolution photon-counting CT.

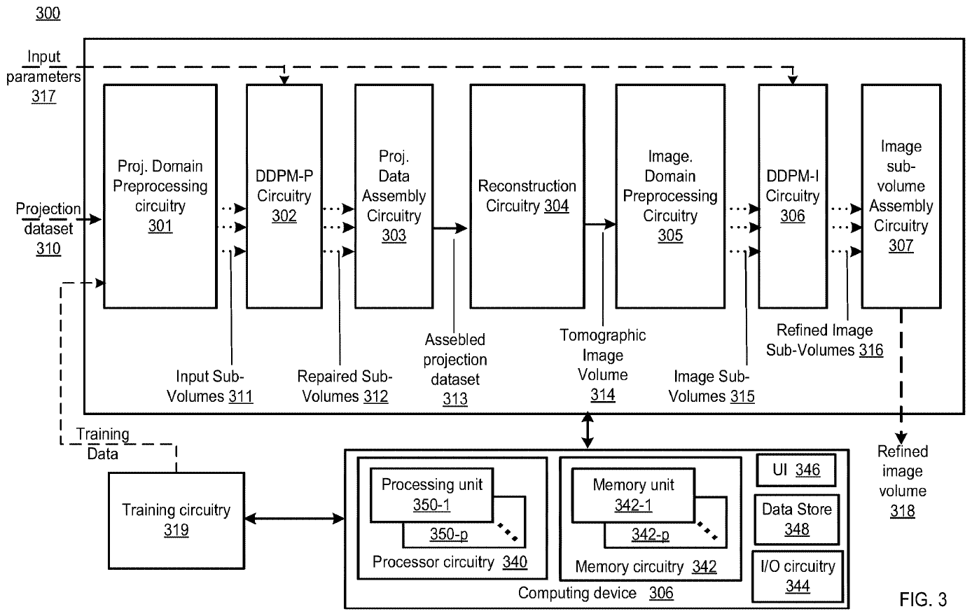

FIG. 3 shows a functional block diagram of a system 300 for inpainting a tomographic image volume according to an embodiment of the present technology. There system comprises one or more processors and one or more computer-readable storage media comprising instructions executable by the one or more processors. The system includes a projection domain preprocessing circuitry 301, a DDPM-P circuitry 302, a projection data assembly circuitry 303, a reconstruction circuitry 304, an image domain preprocessing circuitry 305, a DDPM-I circuitry 306, and an image sub-volume assembly circuitry 307, in some embodiments.

In some embodiments, the instructions comprise: dividing, by the projection domain preprocessing circuitry 301, a projection dataset 310 into a plurality of input sub-volumes 311 of the projection data. In some embodiments, the sub-volumes 311 are non-overlapping cubes. In other embodiments, overlapping sub-volumes are used, including volumes having other shapes. As discussed above, the projection dataset 310 comprises in some embodiments a sparse or “few-view” projection dataset, which includes fewer measurement data points than may be desired by a user.

The instructions also include inpainting, by the DDPM-P circuitry, additional projection data into the input sub-volumes 311 to form a plurality of repaired sub-volumes 312 of projection data. The process of inpainting includes, in some embodiments, the DDPM-based process described herein. In some embodiments, the inpainting of additional projection data is conditioned on the input sub-volume of projection data. In some embodiments, the instructions also include assembling, by the projection data assembly circuitry 303, the plurality of repaired sub-volumes 312 into an assembled projection dataset 313. The instructions also include reconstructing, by the reconstruction circuitry 304, a tomographic image volume 314 from the assembled projection dataset 313. In some embodiment, the reconstruction circuitry applies the Feldkamp-Davis-Kress algorithm for reconstruction.

In some embodiments, the instructions also include dividing, by the image domain preprocessing circuitry 305, the tomographic image volume 314 into a plurality of image sub-volumes 315. In some embodiments, the image sub-volumes 315 are non-overlapping cubes. In other embodiments, overlapping sub-volumes are used, including volumes having other shapes. In some embodiments, the image sub-volumes 315 are passed to the DDPM-I circuitry 305, and the instructions further comprise outputting, by the DDPM-I circuitry, a plurality of refined image sub-volumes 316 based on the image sub-volumes 315. The operations of the DDPM-I circuitry are as described above in some embodiments.

Finally, in some embodiments the instructions include combining, by an image sub-volume assembly circuitry 307, the plurality of refined image sub-volumes 316 to form a refined tomographic image volume 318.

Generally, the system 300 and particularly the DDPM-P and DDPM-I circuitry 302 and 306 are is configured to receive the network parameters, θ, after training, and input parameters 317. For example, the input parameters may include one or more of: a number of time steps, T, the diffusion parameters β₁, and β_{T}, and an under-sampling mask, M, that corresponds to the selected under-sampled tomographic dataset, Z.

Computing device 306 may include, but is not limited to, a computing system (e.g., a server, a workstation computer, a desktop computer, a laptop computer, a tablet computer, an ultraportable computer, an ultramobile computer, a netbook computer and/or a subnotebook computer, etc.), and/or a smart phone. Computing device 306 includes processor circuitry 340, a memory circuitry 342, input/output (I/O) circuitry 344, a user interface (UI) 346, and data store 348. Processor circuitry 340 includes a plurality of processing units 350-1, . . . , 350-p. One or more of the processing units 350-1, . . . , 350-p may include and/or may correspond to a graphics processing unit (GPU).

Processor circuitry 340 is configured to perform operations of system 300, including, for example, a projection domain preprocessing circuitry 301, a DDPM-P circuitry 302, a projection data assembly circuitry 303, a reconstruction circuitry 304, an image domain preprocessing circuitry 305, a DDPM-I circuitry 306, and an image sub-volume assembly circuitry 307.

Memory circuitry 342 (i.e., computer-readable storage media) may include a plurality of memory units 342-1, . . . , 342-p, similar to the processing units 350-1, . . . , 350-p of processor circuitry 340. Thus, each processing unit, e.g., processing unit 350-1, may have an associated memory unit, e.g., memory unit 342-1, configured to store a respective subset of data, as described herein. In one nonlimiting example, each pair of processing unit 350-1 and memory unit 342-1, may be distributed. In some embodiments, therefore, the system 300 comprises a plurality of processors and a first set of the plurality of processors is located at a first node of a distributed computing system and a second set of the plurality of processors is located at a second node of the distributed computing system. In some embodiments, the instructions for inpainting further comprise inpainting a first set of the input sub-volumes 311 at the first node and a second set of the input sub-volumes 311 at the second node; and the instructions for outputting further comprise outputting a first set of refined image sub-volumes 316 the first node and a second set of refined image sub-volumes 316 at the second node.

Memory circuitry 342 may be configured to store data associated with the system 300 and its various components.

I/O circuitry 344 may be configured to provide wired and/or wireless communication functionality the system. For example, I/O circuitry 344 may be configured to receive training input data, and/or input data and parameters 317. UI 346 may include a user input device (e.g., keyboard, mouse, microphone, touch sensitive display, etc.) and/or a user output device, e.g., a display. Data store 348 may be configured to store one or more of training input data, input data and parameters 317, training data, network parameters, and/or other data associated with the system.

In some embodiments, the system 300 further comprises training circuitry 319 which is configured to is configured to receive training input data, and to determine network parameters associated with the DDPM-P and DDPM-I circuitry. In some embodiments, the training input data may include one or more training full-scan projection datasets and other training-related parameters, as described herein, including, e.g., diffusion parameters β₁, and β_{T}. In some embodiments, the training circuitry 319 is configured to train, via instructions on the storage media of the system, the neural network components of the DDPM circuitry, based, at least in part, on training full-scan sub-volumes from a full-scan projection dataset. In some embodiments, the media further comprises instructions for training the DDPM-P circuitry using a plurality of sub-volumes from a full-scan projection dataset, wherein the full-scan sub-volumes are each paired with a corresponding sparse sub-volume from a sparse-view dataset corresponding to the full-scan dataset. In some embodiments, the sparse-view dataset corresponds to the full-scan dataset in that it is a downsampled version of the full-scan dataset.

In some embodiments, the media further comprises instructions for training the DDPM-I circuitry. In some embodiments, the instructions include: inpainting, by the trained DDPM-P circuitry, additional projection data into the plurality of sparse-view sub-volumes to form a plurality of training sub-volumes. The plurality of training sub-volumes are assembled, by the projection data assembly circuitry, into a training projection dataset. The instructions further comprise reconstructing, by the reconstruction circuitry, a training image volume from the training projection dataset. The DDPM-I is trained using pairs of training image sub-volumes from the training image volume and their corresponding image sub-volumes from the full-scan image volume reconstructed from the full-scan projection dataset.

During training in some embodiments, training circuitry 319 is configured to manage training operations of the system 300.

According to another embodiment of the present technology, a method for inpainting a tomographic image volume is provided, comprising the steps of dividing, by a projection domain preprocessing circuitry, a projection dataset into a plurality of input sub-volumes of projection data; inpainting, by a DDPM-P circuitry, additional projection data into the input sub-volumes to form a plurality of repaired sub-volumes of projection data; assembling, by a projection data assembly circuitry, the plurality of repaired sub-volumes into an assembled projection dataset; reconstructing, by a reconstruction circuitry, a tomographic image volume from the assembled projection dataset; dividing, by an image domain preprocessing circuitry, the tomographic image volume into a plurality of image sub-volumes; outputting, by a DDPM-I circuitry, a plurality of refined image sub-volumes based on the image sub-volumes; and combining, by an image sub-volume assembly circuitry, the plurality of refined image sub-volumes to form a refined tomographic image volume.

In some embodiments, the step of inpainting further comprises that at least two input sub-volumes are each inpainted at separate nodes of a distributed computing system. In some embodiments, the step of outputting further comprises that at least two refined image sub-volumes are each outputted at separate nodes of a distributed computing system.

In some embodiments, the reconstruction circuitry applies a Feldkamp-Davis-Kress algorithm.

In some embodiments, the method further comprises the step of training the DDPM-P circuitry using a plurality of sub-volumes from a full-scan projection dataset, wherein the full-scan sub-volumes are each paired with a corresponding sparse sub-volume from a sparse-view dataset corresponding to the full-scan dataset. In some embodiments, the method further comprises the step of training the DDPM-I circuitry by: inpainting, by the trained DDPM-P circuitry, additional projection data into the plurality of sparse-view sub-volumes to form a plurality of training sub-volumes; assembling, by the projection data assembly circuitry, the plurality of training sub-volumes into a training projection dataset; reconstructing, by the reconstruction circuitry, a training image volume from the training projection dataset; and training the DDPM-I using pairs of training image sub-volumes from the training image volume and their corresponding image sub-volumes from the full-scan image volume reconstructed from the full-scan projection dataset. In some embodiments, the training utilizes the AdamW optimizer.

In some embodiments, the inpainting of additional projection data is conditioned on the input sub-volume of projection data.

Other embodiments of the present technology include non-transitory computer-readable storage media and/or devices having stored thereon instructions that when executed by one or more processors perform the methods and processes described herein. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

As used in any embodiment herein, “network”, “model”, “ANN”, and “neural network” (NN) may be used interchangeably, and all refer to an artificial neural network that has an appropriate network architecture. Network architectures may include one or more layers that may be sparse, dense, linear, convolutional, and/or fully connected. It may be appreciated that deep learning includes training an ANN. Each ANN may include, but is not limited to, a deep NN (DNN), a convolutional neural network (CNN), a deep CNN (DCNN), a multilayer perceptron (MLP), etc. Training generally corresponds to “optimizing” the ANN, according to a defined metric, e.g., minimizing a cost (e.g., loss) function.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage media. Firmware may be embodied as code, instructions or instruction sets and/or data that are hard-coded (e.g., nonvolatile) in memory devices.

“Circuitry”, as used in any embodiment herein, may include, for example, singly or in any combination, hardwired circuitry, programmable circuitry such as computer processors comprising one or more individual instruction processing cores (including, but not limited to, graphics processing units), state machine circuitry, and/or firmware that stores instructions executed by programmable circuitry. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Memory circuitry 342 may include one or more of the following types of memory: semiconductor firmware memory, programmable memory, non-volatile memory, read only memory, electrically programmable memory, random access memory, flash memory, magnetic disk memory, solid state memory, and/or optical disk memory. Either additionally or alternatively system memory may include other and/or later-developed types of computer-readable memory.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1. A system for inpainting a tomographic image volume, comprising:
one or more processors; and
one or more computer-readable storage media comprising instructions executable by the one or more processors for:
dividing, by a projection domain preprocessing circuitry, a projection dataset into a plurality of input sub-volumes of projection data;
inpainting, by a DDPM-P circuitry, additional projection data into the input sub-volumes to form a plurality of repaired sub-volumes of projection data;
assembling, by a projection data assembly circuitry, the plurality of repaired sub-volumes into an assembled projection dataset;
reconstructing, by a reconstruction circuitry, a tomographic image volume from the assembled projection dataset;
dividing, by an image domain preprocessing circuitry, the tomographic image volume into a plurality of image sub-volumes;
outputting, by a DDPM-I circuitry, a plurality of refined image sub-volumes based on the image sub-volumes; and
combining, by an image sub-volume assembly circuitry, the plurality of refined image sub-volumes to form a refined tomographic image volume.

2. The system of claim 1, further comprising a plurality of processors and that a first set of the plurality of processors is located at a first node of a distributed computing system and a second set of the plurality of processors is located at a second node of the distributed computing system.

3. The system of claim 2, wherein the instructions for inpainting further comprise inpainting a first set of the input sub-volumes at the first node and a second set of the input sub-volumes at the second node; and wherein the instructions for outputting further comprise outputting a first set of refined image sub-volumes the first node and a second set of refined image sub-volumes at the second node.

4. The system according to any claim 1, wherein the media further comprises instructions for training the DDPM-P circuitry using a plurality of sub-volumes from a full-scan projection dataset, wherein the full-scan sub-volumes are each paired with a corresponding sparse sub-volume from a sparse-view dataset corresponding to the full-scan dataset.

5. The system of claim 4, wherein the media further comprises instructions for training the DDPM-I circuitry by:
inpainting, by the trained DDPM-P circuitry, additional projection data into the plurality of sparse-view sub-volumes to form a plurality of training sub-volumes;
assembling, by the projection data assembly circuitry, the plurality of training sub-volumes into a training projection dataset;
reconstructing, by the reconstruction circuitry, a training image volume from the training projection dataset;
training the DDPM-I using pairs of training image sub-volumes from the training image volume and their corresponding image sub-volumes from the full-scan image volume reconstructed from the full-scan projection dataset.

6. A method for inpainting a tomographic image volume, the method comprising the steps of:
dividing, by a projection domain preprocessing circuitry, a projection dataset into a plurality of input sub-volumes of projection data;
inpainting, by a DDPM-P circuitry, additional projection data into the input sub-volumes to form a plurality of repaired sub-volumes of projection data;
assembling, by a projection data assembly circuitry, the plurality of repaired sub-volumes into an assembled projection dataset;
reconstructing, by a reconstruction circuitry, a tomographic image volume from the assembled projection dataset;
dividing, by an image domain preprocessing circuitry, the tomographic image volume into a plurality of image sub-volumes;
outputting, by a DDPM-I circuitry, a plurality of refined image sub-volumes based on the image sub-volumes; and
combining, by an image sub-volume assembly circuitry, the plurality of refined image sub-volumes to form a refined tomographic image volume.

7. The method of claim 6, wherein the step of inpainting further comprises that at least two input sub-volumes are each inpainted at separate nodes of a distributed computing system.

8. The method of claim 6, wherein the step of outputting further comprises that at least two refined image sub-volumes are each outputted at separate nodes of a distributed computing system.

9. The method of claim 6, wherein the reconstruction circuitry applies a Feldkamp-Davis-Kress algorithm.

10. The method of claim 6, further comprising the step of training the DDPM-P circuitry using a plurality of sub-volumes from a full-scan projection dataset, wherein the full-scan sub-volumes are each paired with a corresponding sparse sub-volume from a sparse-view dataset corresponding to the full-scan dataset.

11. The method of claim 10, further comprising the step of training the DDPM-I circuitry by:
inpainting, by the trained DDPM-P circuitry, additional projection data into the plurality of sparse-view sub-volumes to form a plurality of training sub-volumes;
assembling, by the projection data assembly circuitry, the plurality of training sub-volumes into a training projection dataset;
reconstructing, by the reconstruction circuitry, a training image volume from the training projection dataset; and
training the DDPM-I using pairs of training image sub-volumes from the training image volume and their corresponding image sub-volumes from the full-scan image volume reconstructed from the full-scan projection dataset.

12. The method of claim 11, wherein the training utilizes the AdamW optimizer.

13. The method of claim 6, wherein the inpainting of additional projection data is conditioned on the input sub-volume of projection data.

14. One or more non-transitory computer-readable storage media comprising instructions executable by the one or more processors for inpainting a tomographic image volume by:
dividing, by a projection domain preprocessing circuitry, a projection dataset into a plurality of input sub-volumes of the projection data;
inpainting, by a DDPM-P circuitry, additional projection data into the input sub-volumes to form a plurality of repaired sub-volumes of projection data;
assembling, by a projection data assembly circuitry, the plurality of repaired sub-volumes into an assembled projection dataset;
reconstructing, by a reconstruction circuitry, a tomographic image volume from the assembled projection dataset;
dividing, by an image domain preprocessing circuitry, the tomographic image volume into a plurality of image sub-volumes;
outputting, by a DDPM-I circuitry, a plurality of refined image sub-volumes based on the image sub-volumes; and
combining, by an image sub-volume assembly circuitry, the plurality of refined image sub-volumes to form a refined tomographic image volume.

15. The media of claim 14, wherein the instructions for inpainting further comprise that at least two input sub-volumes are each inpainted at separate nodes of a distributed computing system.

16. The media of claim 14, wherein the instructions for outputting further comprises that at least two refined image sub-volumes are each outputted at separate nodes of a distributed computing system.

17. The media of claim 14, wherein the reconstruction circuitry applies a Feldkamp-Davis-Kress algorithm.

18. The media of claim 14, further comprising instructions for training the DDPM-P circuitry using a plurality of sub-volumes from a full-scan projection dataset, wherein the full-scan sub-volumes are each paired with a corresponding sparse sub-volume from a sparse-view dataset corresponding to the full-scan dataset.

19. The media of claim 18, further comprising instructions for training the DDPM-I circuitry by:
inpainting, by the trained DDPM-P circuitry, additional projection data into the plurality of sparse-view sub-volumes to form a plurality of training sub-volumes;
assembling, by the projection data assembly circuitry, the plurality of training sub-volumes into a training projection dataset;
reconstructing, by the reconstruction circuitry, a training image volume from the training projection dataset;
training the DDPM-I using pairs of training image sub-volumes from the training image volume and their corresponding image sub-volumes from the full-scan image volume reconstructed from the full-scan projection dataset.

20. The media of claim 14, wherein the inpainting of additional projection data is conditioned on the input sub-volume of projection data.
